(19) United States
(12) Patent Application Publication
(10) Pub. No.: US 2002/0186455 A1
(43) Pub. Date: Dec. 12, 2002

(54) Optical composite ion/host crystal gain elements

(76) Inventors: Peter A. Ketteridge, Amherst, NH (US); Peter A. Budni, Nashua, NH (US); Evan Chicklis, Manchester, NH (US); Michael P. Schmidt, Hollis, NH (US); Scott D. Setzler, Manchester, NH (US)

Correspondence Address: DEVINE, MILLIMET & BRANCH, P.A., 111 AMHERST STREET, BOX 719, MANCHESTER, NH, 03105, US

(21) Appl. No.: 10/164,500

(22) Filed: Jun. 6, 2002

Related U.S. Application Data
(60) Provisional application No. 60/296,412, filed on Jun. 6, 2001.

(51) Int. Cl. H01S 3/00

(52) U.S. Cl. 359/333

(57) ABSTRACT

The present invention is an amplifier for amplifying an optical signal. The signal to be amplified passes into and then from a first optical manipulator. The first manipulator is at least one or more collimators and/or concentrators. The amplifier includes an input pump which produces pump light overlapping the optical signal as the signal passes from the first manipulator. The amplifier further includes a plurality of ion-doped crystalline hosts to be excited by the pump light and impinged by the signal. Finally the signal passes through a second manipulator, which is also one or more collimators and/or concentrators, and exits the amplifier.

The present application claims the benefit of Provisional Application Serial No. 60/296,412, which was filed Jun. 6, 2001 and is fully incorporated herein by reference.

### FIELD OF THE INVENTION

The field of the present invention is light amplification. Specifically, the present invention is directed towards improved optical amplifiers.

### BACKGROUND OF THE INVENTION

There currently exists a need in the optic transmission industry for an efficient amplifier in the 1.53 to 1.65 micron spectral region. The need is based on an expectation that future optical systems will utilize the full fiber transmission region from approximately 1.3 to 1.6 microns.

Current glass fiber photonic amplifiers rely on the implantation of active ions, which, possessing the proper energy level excited state structures provide optical gain, in desired wavelength regions. Current glass hosts, by their intrinsic disordered nature, exhibit low-gain cross-sections with penalties paid in optical gain and narrow optical gain bandwidth, typically from 1.53 to 1.58 microns. These low gain cross-sections predicate long lengths of glass fiber to provide amplification levels.

Crystal amplifiers have been investigated as an alternative to fiber amplifiers in the past. However, crystal amplifiers have routinely been found inefficient and produced insufficient gain for optical amplifier needs. There is a need in the optic transmission industry to develop an efficient crystal amplifier with sufficient gains for satisfying optical amplifier needs.

### SUMMARY OF THE INVENTION

The present invention results from the realization that composite ion-doped crystalline hosts provide usable and/or desirable gain at reduced lengths as well as gain and energy levels at broader wavelengths than typical glass hosts. The lengths of required composite ion-doped crystalline hosts are approximately a hundred times less than comparable glass hosts. By careful crystal host selection, specific gain ions situated in specific crystal hosts at predetermined concentrations can provide gain in specific, discrete spectral regions. The engineered selected combinations of ions and crystal hosts can broaden the usable spectral gain bandwidth of individual ion/host combinations. An additional technique is herein described where these optimized ion/host combinations can be assembled as a composite gain crystal.

The emission spectral characteristics of Erbium and other related rare earth ions in the various assembled hosts allow for broadband amplifier performance heretofore unachievable in a single glass or crystal host/ion combination. The combination of hosts and ions can provide high gain over the entire usable transmission spectrum of present and future proposed optical system formulations.

Therefore, it is an object of the present invention to provide short, conventional, and long band coverage in a single device.

It is a further object of the present invention to provide higher gain and energy with side pumped inputs and gain path geometry.

It is a further object of the present invention to provide greater than 20-decibel gain with reduced volume and enhanced optical efficiencies.

It is a further object of the present invention to provide inherent gain flatness engineering with specific composite type, doping concentration and gain/pump path geometry.

It is a further object of the present invention to provide reduced noise figure performance with lower host intrinsic Amplified Spontaneous Emission.

### BRIEF DESCRIPTION OF THE DRAWINGS

These and other features and advantages of the present invention will be better understood by reading the following detailed description, taken together with the drawings wherein:

FIG. 1 is a three-dimensional view of a composite gain crystal amplifier.

FIG. 2 is an absorption and emission cross-section of erbium-doped yttrium aluminum garnet (Er:YAG).

FIG. 3 is an absorption and emission cross-section of erbium-doped yttrium vanadate (Er:YVO) for

FIG. 4 shows gain cross-sections of Er:YAG at 30% inversion and polarized Er:YVO₄ at 50% inversion.

FIG. 5 is a pump schematic of a composite gain amplifier/oscillator.

FIG. 6 shows a composite of crystals with high level doping of Erbium.

FIG. 7 shows an aggregate of crystals with high level doping of Erbium in a binder.

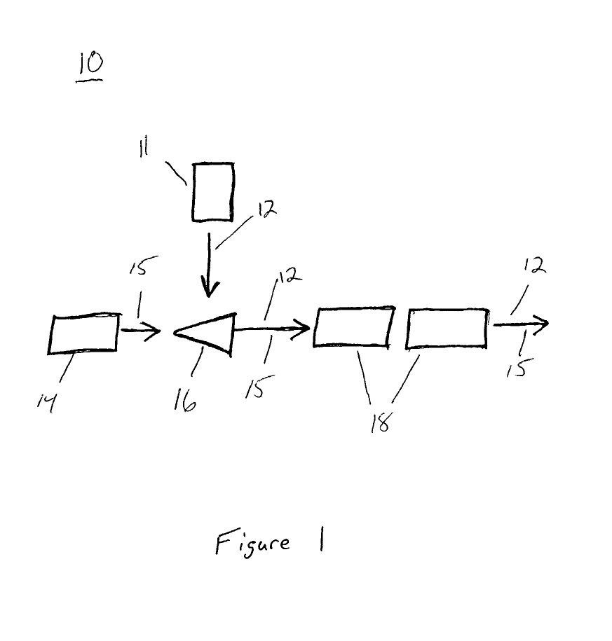

### DETAILED DESCRIPTION OF THE INVENTION

The present invention is an amplifier 10 for amplifying a broadband signal 12. The amplifier 10 includes a signal source 11 originating the signal 12. The signal 12 first passes into a first signal manipulator 16. The first signal manipulator 16 is one or more collimators and/or concentrators as well as dichroics or optical manipulators known to those skilled in the art. An input pump 14 is aligned to overlap the signal 12 with pump light 15. From the first signal manipulator 16, the signal 12 and the pump light 15 intersect the ion-doped crystalline hosts 18, wherein the pump light 15 excites the hosts 18 and the signal 12 impinges the hosts 18, amplifying the signal 12.

In a preferred embodiment, the signal 12 passes through a second optical manipulator 20, which is also at least one or more collimators and/or concentrators.

A narrower embodiment of the invention would include making the input pump 14 one or more laser diode side pumps. Alternatively, another embodiment of the invention would involve making the input pump a back pump.

Another narrower embodiment would involve the manipulators having one or more dichroics.

Another narrower embodiment of the invention would involve doping the plurality of hosts 18 with quasi-third level ions. This embodiment can be further narrowed by Erbium doping at least one of the crystals.

The specific application for the gain device will drive the individual active ion/host choices. Gain level and flatness, size, volume and optical efficiencies for long or short-range use can be optimized at the ion/host integration level. Other application that require higher power levels, such as free space links, could use these crystal gain assemblies for broader operational wavelength capabilities with improved range and adverse weather performance. Longer wavelengths experience reduced attenuation and scatter through poor atmospheric conditions.

In summary, the present invention uses various single-crystal hosts and active ion combinations to extend and custom tune optical gain spectrums, efficiencies and associated amplifier parameters. The combination of these ion/host can be varied to provide the optical system designer gain in desired, broad spectral regions in a compact form.

By using a series of different crystals, one can blend the gain/wavelength curves to achieve a flatter gain profile. One may find that the peak gain wavelength of one crystal type aligns with the minimum gain wavelength of another. By aligning two crystals in series, one effectively blends the two curves. There are many different crystal types that one could consider using for an optical amplifier, but they must be growable in significant enough size, and reasonable cost to be useful. Examples of these include Erbium doped YAG, YFL, YALO etc. There are other crystals that may have useful gain/wavelength curves, but do not grow well in required sizes.

One embodiment of the invention is described herein. The critical energy levels for a 1.5-1.6 micron erbium amplifier are the first excited state (⁴I_{13/2}) and the ground state (⁴I_{15/2}) of the trivalent erbium ion (Er³⁺). Many crystalline materials, or hosts, will support the trivalent state of erbium as a substitute for a constituent element. For example, doping erbium into yttrium lithium fluoride (YLiF₄, or YLF) results in Er³⁺ ions on sites Y³⁺ ions typically occupy. The local electric field at the ion location is strongly host-dependent, so the spectral dependence of absorption from the ⁴I_{15/2} ⁴I_{13/2} transition (and similarly the fluorescence from the ⁴I_{13/2} ⁴I_{15/2} transition) is quite unique for any host.

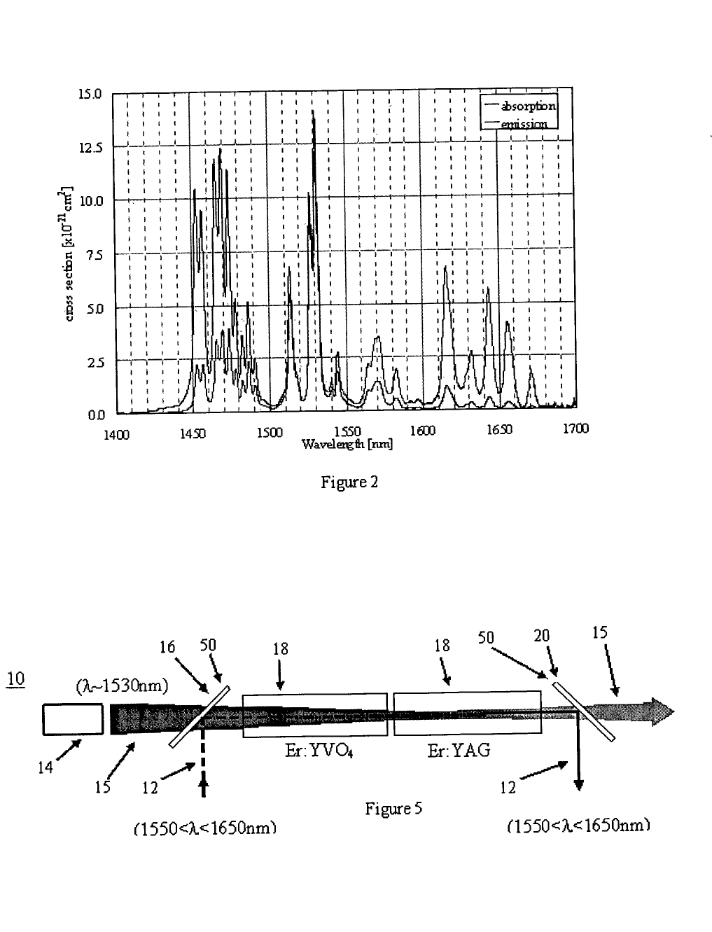

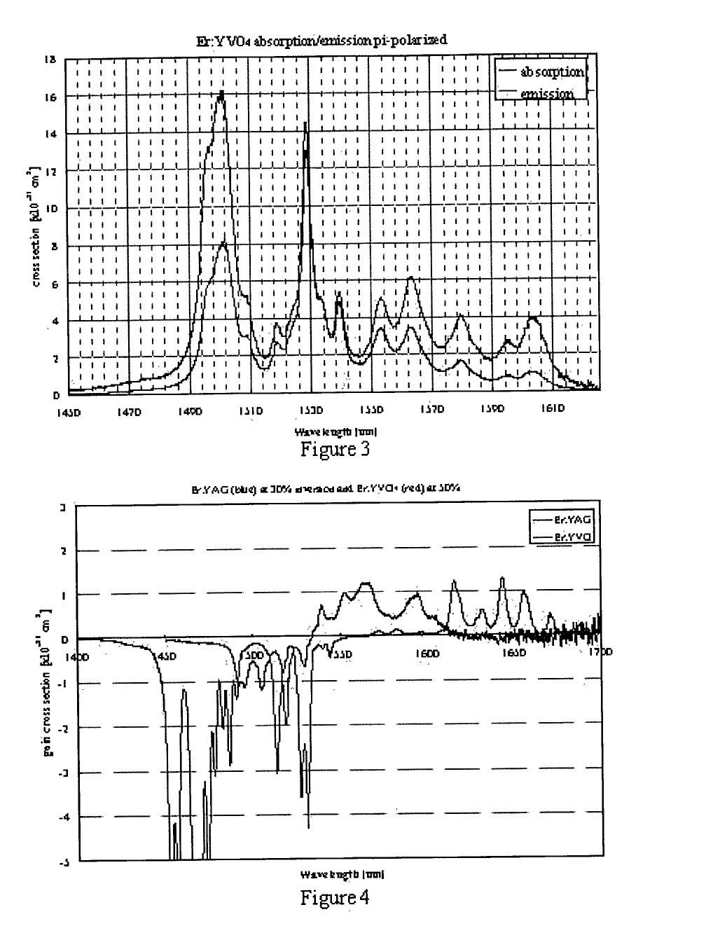

The gain cross-section (σ_{g}) for any host can be derived from the absorption and emission cross-sections as well as the inversion. The inversion (β) is the ratio of ions in the first excited state (N_{13/2}) to the total number of erbium ions (N_{Er}). As an example, the absorption (σₐ) and emission (σₑ) cross-sections for both Er:YAG (erbium-doped yttrium aluminum garnet) and Er:YVO₄ (erbium-doped yttrium vanadate) are shown in FIGS. 2 and 3 below. From this data, the gain cross-section is dependent on inversion as:

σ_{g}=βσₑ−(1−β)σₐ

If two laser-quality samples of Er:YAG and Er:YVO₄ are excited to 30% and 50% inversion, respectively, the gain cross-sections of the pair would be as shown in FIG. 4. One possible means of achieving such an inversion is to place the two ion-doped crystalline hosts 18 end-to-end and pump them sequentially (as shown in FIG. 5). FIGS. 2 & 3 indicate that YAG and YVO₄ are both absorbing at ˜1530 nm, so careful tailoring of pump light 15 intensity, dopant concentration, and crystalline host 18 length can provide an inversion of 50% in the YVO₄, where a majority of the energy is deposited. There will still be enough pump light 15 left, however, to excite the YAG to 30% inversion. This gain deposition can then be used for either amplification (also shown in FIG. 5), or as a two-color laser if placed in a resonant cavity. Active regions of oscillation in this case are from ˜1550 nm to ˜1650 nm. Typically such broad active gain regions are not possible in materials with large cross-sections, but this technique provides both bandwidth and peak cross-section.

The composite gain array can be either end-pumped (colinearly) or side pumped (transversely) relative to the signal direction. In the absence of an external signal source 11, however, the excited gain medium can be placed inside an optical resonator 42 as shown in FIG. 8. In the figure, the optically aligned crystalline hosts 18 are end-pumped, and the resonator 42 is folded into the pump path to optimize overlap of the pump light 15 and resonator axes. The resonator 42 consists of one mirror 46 highly reflective at the high-gain wavelengths (˜1550-1650 nm for erbium), and another mirror 48 partially reflective at the same wavelengths. The 45° dichroics 50 pass the pump light 15 and highly reflect the resonant light. In this geometry, the photon background noise, or the spontaneous generation of a photon with wavelength inside the gain bandwidth can act as a signal source 11. Amplification of the photon noise then produces laser action at the appropriate wavelength. Since the composite gain array has multiple hosts 18, this signal 12 is capable of generating multiple independent laser lines.

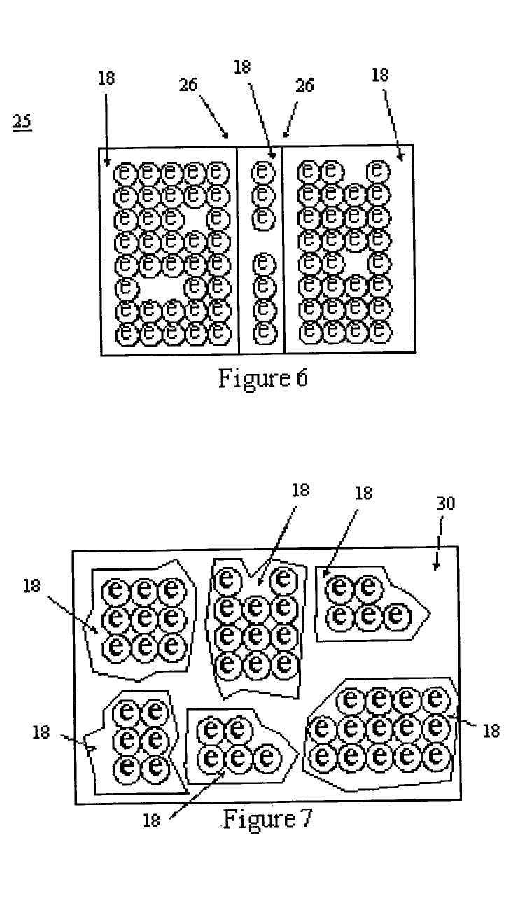

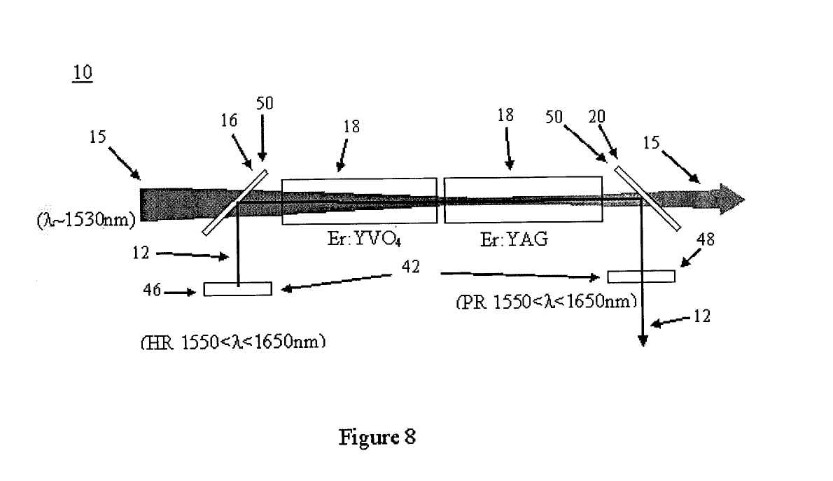

To engineer a composite crystal structure, as shown in FIG. 6, one must select the crystals of interest, determine the length of each, and their position within the crystalline host stack-up 25. Optionally, the crystals are interattached by adhesive 26. There are tradeoffs required in this design process that involve managing the pump light 15 absorbed, up converted, and transmitted, so that each stage gets the proper amount of pump light 15 and minimize the other undesirable effects. With a given set of hosts one will not be able to optimize out all the undesirable effects of the stack-up 25, but one may get close given the materials, desired gain and bandwidths required. This becomes a relatively difficult problem with high gains and wide bandwidths where 3 or more crystal types are desired in the composite structure.

A solution to this problem is a Crystalline Optical Concrete Amplifier (“COCA”). COCAs involve taking a number of types of amplifying ion-doped crystalline hosts 18 ground into an aggregate powder and placing them in an amorphous binder 30 such as glass of similar index of refraction material, as shown in FIG. 7. The use of the term “concrete” refers to the concept of an aggregate in binder just like concrete used in the construction industry. However, in this case “optical concrete” is made up of ground amplifying crystalline hosts 18 and an amorphous optically matched binder material 30.

Amplifying crystalline hosts 18 will be selected that have the desired gain/wavelength properties for the bands being covered in the design. Examples include but are not limited to Erbium doped YAG, YLF, YALO and Calcium Gallium Sulfide. In theory, 10s or even 100s of different ion-doped crystalline hosts 18 in varying level may be used in one COCA point design. With proper aggregate selection however, COCAs could be created of much wider bandwidth than traditional doped glass.

Another advantage of designing a COCA versus a crystal amplifier with a host stack-up 25 is that one need not worry about optimizing a stack-up 25 for proper pump light 15 proliferation. All the crystals by virtue of being intermixed with each other create a natural evenness of incident pump light 15 on each crystal.

This approach has the advantage that crystals may be used that could not have been used for crystal amplifier with a host stack-up 25 because they could not be grown in sufficient size. As the crystalline hosts 18 will be ground to a fine power, less expensive crystalline materials can be also used as one need not worry about macroscopic defects in the crystals larger than the desire aggregate size. For example, a boule of YAG with significant occlusions is just as useful as one without occlusions. So one can optimize the growing of crystals for speed and cost, versus macroscopic optical purity.

Once the amplifying crystalline hosts 18 have been selected, one may choose to test a sample for performance. The crystalline hosts 18 are then ground into a fine powder aggregate. Aggregate of undesirable size is then sifted out and the correct size aggregate for the design is used. The aggregate of all the different crystal types is then mixed into a combined powder with proportions driven by the gain and bandwidth requirements of the design.

A binder 30 must be selected that has a lower melting point (or annealing point) than the optical aggregate, nor alter its amplifying properties. An example of this might be a low temperature glass or certain polymers with an index of refraction similar to the crystalline aggregate. By matching the index of refraction, one need not worry as much about scattering issues and such that would result from a mismatched system.

The aggregate is added to the binder 30 in a relatively strong concentration, as the volume of aggregate, not binder 30, will drive the required size of the resulting COCA. Plus, there are no negative up conversion aspects associated with this macroscopic density of aggregate. That all takes place at a much more microscopic level. However, one must deal with the structural aspects the binder 30 with aggregate so as to end up with a mechanically sturdy COCA. Crystalline hosts 18 may be added to the binder 30 with the binder 30 in a liquid form at temperature, or with ground solid binder 30 before it is melted. This depends of the materials and manufacturing processes of the particular COCA.

The size of the aggregate is also important based on the goals of the design. There are two basic approaches on can take. Take an amplifier for traditional C-Band fiberoptic cable with wavelengths slightly above 1500 nm. If the aggregate is significantly smaller than the wavelength, then the aggregate appears as essentially a bulk effect with little effect on the direction of the light as it passes through the optical concrete. Assume an average aggregate size of 0.1 micron, about 1/10 the wavelength, while also having a binder that is a reasonable index of refraction match. With an aggregate size of 0.1 micron, there would still be about 1 million or so Erbium atoms in each crystalline host. So they will still interact with each other in a manner still driven by the aggregate material. The extent to which the size of the aggregate does affect the gain/frequency characteristics may actually be a positive quality, as the varying size of the aggregate will tend to spread out the gain/frequency characteristics to some extent.

One could certainly build an amplifier 10 with aggregate that is much larger than a wavelength, however, it will create the diffused light due to large quantity of surfaces with even minor index of refraction mismatches. This will cause multi-path problems that spread high frequency optical waveforms, as well as create the need for a collimating structure in the amplifier 10. There is an advantage of not needing to create such fine grain crystal aggregate however.

Another advantage of small aggregate is that it may be added to an amorphous binder 30 such as glass. Thus, it can be formed into a single mode fiber, molded into a wave guide amplifier, or deposited onto a surface on an integrated circuit based amplifier similar to how those devices are built today. Forming a COCA into a single mode fiber would result in an amplifier a few centimeters in length as compared to the current long coils. It also would make physical attachments to other devices straightforward without having to worry about collimating the light from a larger diameter structure. Keeping the diameter of the fiber small also deals with any spreading of the light easily.

If one used small aggregate sized COCAs to build a waveguide style amplifier, one could create larger gains, making the technology suitable for the long haul marketplace. As this is a slightly more macroscopic structure than the single mode fiber approach, one would need to be careful with the aggregate size in controlling the amount of diffusion cause by the aggregate/binder index mismatch.

Modifications and substitutions by one of ordinary skill in the art are considered to be within the scope of the present invention, which is not to be limited except by the following claims.

We claim:

1. An amplifier for amplifying a broadband signal, said amplifier comprising:
a signal source for generating the signal;
a first optical manipulator aligned with the signal, said first manipulator consisting of at least one of the group of at least one collimator and at least one concentrator;
an input pump aligned to overlap the signal with a pump light; and
a plurality of ion doped crystalline hosts placed to be excited by the pump light and impinged by the signal after the first manipulator.

2. The amplifier of claim 1 further comprising a second optical manipulator aligned to receive the amplified signal from the hosts, said second manipulator consisting of at least one of the group of at least one collimator and at least one concentrator.

3. The amplifier of claim 1 wherein the input pump comprises at least one laser diode side pump.

4. The amplifier of claim 1 wherein the input pump comprises at least one laser diode end pump.

5. The amplifier of claim 1 wherein the manipulator further comprises at least one dichroic.

6. The amplifier of claim 5 wherein the hosts are doped with quasi-three level ions.

7. The amplifier of claim 5 wherein at least one of the crystals is Erbium doped.

8. The amplifier of claim 3 wherein the plurality of crystals are aligned in series.

9. The amplifier of claim 8 wherein the plurality of crystals are adhesively interattached.

10. The amplifier of claim 8 wherein the plurality of crystals are optically aligned.

11. The amplifier of claim 1 wherein the hosts further comprise a plurality of finely ground crystals in an amorphous binder.

12. The amplifier of claim 8 wherein the ground crystals and the binder have a substantially similar index of refraction.

13. The amplifier of claim 2 wherein:
the hosts further comprise a plurality of finely ground crystals in an amorphous binder;
the ground crystals and the binder have a substantially similar index of refraction; and
a fiber optic cable is aligned to receive the signal from the second manipulator.

14. The amplifier of claim 13 wherein at least a portion of the ground crystals are of a size smaller than a wavelength of the signal.

15. The amplifier of claim 13 wherein the ground crystals are of an aggregate size below 0.1 microns.

16. The amplifier of claim 1 further comprising an optical resonator containing the excited hosts.

17. The amplifier of claim 16 wherein the resonator is capable of producing a multi-wavelength output.
